(19) United States
(12) Patent Application Publication
(10) Pub. No.: US 2005/0198272 A1
(43) Pub. Date: Sep. 8, 2005

(54) System, method, and apparatus for connectivity testing

(76) Inventors: Marc R. Bernard, Pembroke Pines, FL (US); Nora Herndon, Coral Springs, FL (US); Moshe Oron, San Rafael, CA (US); Iris Lopez, Miami, FL (US)

Correspondence Address: PILLSBURY WINTHROP SHAW PITTMAN LLP, P.O. BOX 10500, MCLEAN, VA, 22102, US

(21) Appl. No.: 10/785,722

(22) Filed: Feb. 23, 2004

(51) Int. Cl. G06F 15/173; G06F 11/00

(52) U.S. Cl. 709/224; 714/4

(57) ABSTRACT

A method and apparatus according to embodiments of the invention include monitoring connectivity between an OLT and at least one network termination node. The OLT sends a connectivity test signal to the network termination node under test and receives a responsive signal.

### FIELD OF THE INVENTION

The invention relates generally to communications networks and more particularly to network connectivity.

### BACKGROUND

The following acronyms may appear in the description below: APON, asynchronous transfer mode (ATM) passive optical network (PON); ASIC, application-specific integrated circuit; ATM, asynchronous transfer mode; B-PON or BPON (broadband PON); CATV, community access television (cable television); CPU, central processing unit (e.g. microprocessor); EPON (Ethernet PON); FPGA, field-programmable gate array; ISDN, integrated services digital network; PON, passive optical network; POTS, plain old telephone service; PPV, pay per view; RAM, random-access memory; ROM, read-only memory; VoIP, voice over Internet Protocol; VoATM, voice over ATM; VoD, video on demand; ONT, optical network termination; OMCI, ONT management and control interface; EMS, element management system; TCID, trans correlation identifier.

Optical access systems offer a potentially large bandwidth as compared to copper-based access systems. A broadband optical access system may be used, for example, to distribute a variety of broadband and narrowband communication services from a service provider's facility to a local distribution point and/or directly to the customer premises. These communication services may include telephone (e.g. POTS, VoIP, VOATM), data (e.g. ISDN, Ethernet), and/or video/audio (e.g. television, CATV, PPV, VoD) services.

FIG. 1 shows examples of two optical access network (OAN) architectures. The first example includes an optical line termination (OLT), an optical distribution network (ODN), an optical network unit (ONU), and a network termination (NT). The OLT provides the network-side interface of the OAN (e.g. a service node interface or SNI), and it may be located at a carrier's central office or connected to a central office via a fibre trunk (e.g. the OLT may include an OC-3/STM-1 or OC-12c interface).

The OLT may be implemented as a stand-alone unit or as a card in a backplane. The AccessMAX OLT card of Advanced Fibre Communications (Petaluma, CA) is one example of a superior OLT product. Other examples of OLTs include the 7340 line of OLTs of Alcatel (Paris, France), the FiberDrive OLT of Optical Solutions (Minneapolis, Minn.), and assemblies including the TK3721 EPON media access controller device of Teknovus, Inc. (Petaluma, CA). The OLT may communicate (e.g. via cable, bus, and/or data communications network (DCN)) with a management system such as an element management system (EMS), a network element operations system (NE-OpS), or another management entity that manages the network and/or equipment.

On the user side, the OLT may be connected to one or more ODNs. An ODN provides one or more optical paths between an OLT and one or more ONUs. The ODN provides these paths over one or more optical fibres which may have lengths measured in feet or in kilometers. The ODN may also include optional protection fibres (e.g. for backup in case of a break in a primary path).

An optical network unit (ONU) is connected to an ODN and provides (either directly or remotely) a user-side interface of the OAN. The ONU, which may serve as a subscriber terminal, may be located outside (e.g. on a utility pole) or inside a building. One or more network terminations (NTs) are connected to an ONU (e.g. via copper trace, wire, and/or cable) to provide user network interfaces (UNIs), e.g. for services such as Ethernet, video, and ATM. Implementations of such an architecture include arrangements commonly termed Fibre to the Building (FTTB), Fibre to the Curb (FTTC), and Fibre to the Cabinet (FTTCab).

One example of an ONU includes the XN230 APON media access controller device of BroadLight Ltd. (Ramat-Gan, Isreal) combined with an external CPU (and possibly other devices including an optoelectronic interface and interfaces for one or more of ATM, Ethernet, TI, video, and POTS). The XN230 device may be used to provide up to five logical ONUs. Another example of an ONU includes the MC92701 BPON layer termination device of Motorola Inc. (Schaumberg, Ill.) combined with an external CPU.

The second architecture example in FIG. 1 includes an OLT, an ODN, and one or more optical network terminations (ONTs). An ONT is an implementation of an ONU that includes a user port function. The ONT, which may be active, serves to decouple the access network delivery mechanism from the distribution at the customer premises (e.g. a single-family house or a multi-dwelling unit or business establishment). Implementations of such an architecture include arrangements commonly termed Fibre to the Home (FTTH). In some applications, an ONT may be wall-mounted.

The AccessMAX ONT of Advanced Fibre Communications (Petaluma, CA) is one example of a superior ONT product. Other examples of ONTs include the Exxtenz ONT of Carrier Access Corporation (Boulder, Colo.), the FiberPath 400 and 500 lines of ONTs of Optical Solutions, the 7340 line of ONTs of Alcatel, and assemblies including the TK3701 device of Teknovus, Inc.

As shown in FIG. 1, an OAN may include a number of ODNs connected to the same OLT. As shown in FIG. 2, an ODN may connect an OLT to multiple ONUs. An ODN may also be connected to both ONUs and ONTs. In some applications, the nominal bit rate of the OLT-to-ONU signal may be selected from the rates 155.52 Mbit/s and 622.08 Mbit/s.

An ODN that contains only passive components (e.g. fibre and optical splitters and/or combiners) may also be referred to as a passive optical network (PON). Depending e.g. on the particular intended application, a PON may also be referred to as a B-PON (broadband PON), EPON (Ethernet PON), or APON (ATM PON). A OAN may include different OLTs and/or ONUs to handle different types of data traffic (e.g. Ethernet, ATM, video), and/or a single OLT or ONU may handle more than one type of data traffic. The OLT and/or one or more of the ONUs may be provided with battery backup (e.g. an uninterruptible power supply (UPS)) in case of mains power failure.

FIG. 3 shows an example of a OLT connected to a PON that includes a four-way splitter 20 and four eight-way splitters 30a-d. In this example, each of up to thirty-two ONUs may be connected to the PON via a different output port of splitters 30a-d (where the small circles represent the PON nodes depending from these ports). Other PON configurations may include different splitter arrangements. In some such configurations, for example, a path between the OLT and one ONU may pass through a different number of splitters than a path between the OLT and another ONU.

Operation of a OAN may include ranging. A ranging operation may be performed, for example, to quantify a time delay for transmissions between the OLT and ONU. A ranging operation may also include discovery of a newly installed ONU. Once an ONU has been successfully ranged, it becomes active on the network.

The protocol for communications between the OLT and the ONUs may be ATM-based (e.g. such that the OLT and ONUs provide transparent ATM transport service between the SNI and the UNIs over the PON), although embodiments of the invention as disclosed herein may also be applied to optical access networks in which such communications are based on other protocols (e.g. Ethernet). Embodiments of the invention may also be applied to optical access systems that comply with one or more of ITU-T Recommendations G.983.1 (“Broadband optical access systems based on Passive Optical Networks (PON),” dated October 1998 and as corrected July 1999 and March 2002 and amended November 2001 and March 2003, along with Implementor's Guide of October 2003) and G.983.2 (“ONT management and control interface specification for B-PON,” dated June 2002 and as amended March 2003, along with Implementor's Guide of April 2000) (International Telecommunication Union, Geneva, CH). Additional aspects of optical access systems to which embodiments of the invention may be applied are described in the aforementioned Recommendations.

### SUMMARY

A method according to one embodiment of the invention includes transmitting a signal from an OLT to at least one active network termination and, subsequent to the transmitting, detecting a responsive signal from the active network termination. The method further includes, based on the detecting, determining a result of a connectivity test, and reporting the result to a network management system.

An apparatus according to an embodiment of the invention includes a first signal generator configured and arranged to transmit a signal to at least one network termination; a signal detector configured and arranged to receive a responsive signal from the network termination; and a logic unit configured and arranged to determine, based on the received responsive signal, a result of a connectivity test. The apparatus also includes a second signal generator configured and arranged to report the result to the network management system.

### BRIEF DESCRIPTION OF THE DRAWINGS

FIG. 1 shows examples of two OAN architectures.

FIG. 2 shows an example of an OAN.

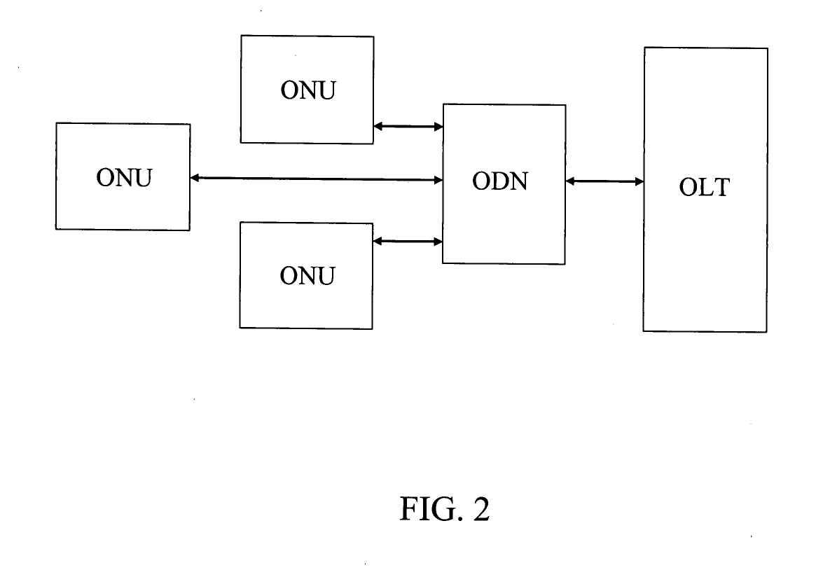

FIG. 3 shows an example of an OLT and a PON including splitters.

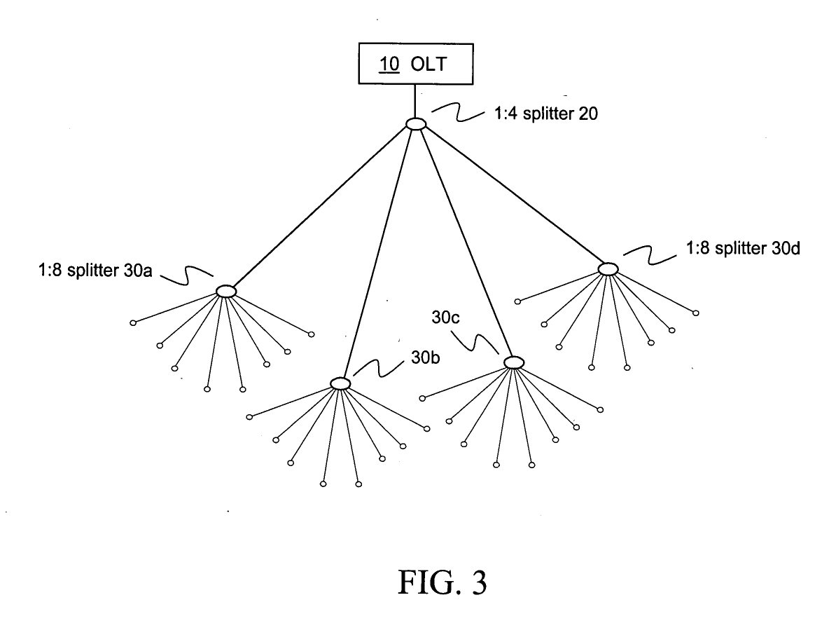

FIG. 4 is a block diagram illustrating an apparatus in accordance with an embodiment of the present invention.

FIG. 5 is a block diagram illustrating a system in accordance with an embodiment of the present invention.

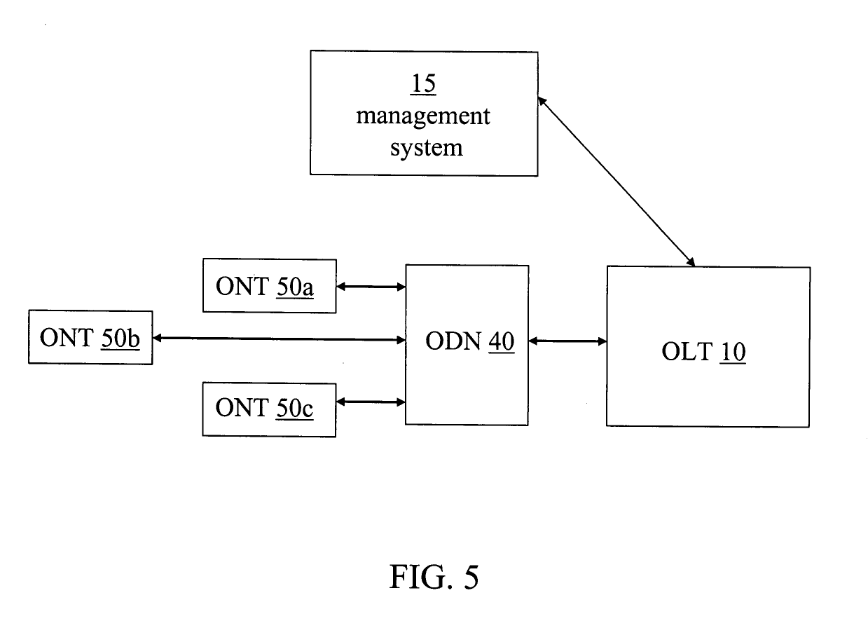

FIG. 6 is a block diagram illustrating a system including a data storage medium in accordance with an embodiment of the present invention.

### DETAILED DESCRIPTION

Within an optical network, the physical connections may be monitored using a system for detecting a loss of signal (LOS) with respect to each of the ONUs with which it communicates. In response to such detection, the OLT may be configured to declare an LOS condition for that ONU (e.g. to a management function or entity). In the event that a break occurs in the ODN (e.g. a fibre is cut or unplugged), such an OLT will declare an LOS condition for each of the ONUs that are cut off from it by the break.

One example of LOS detection is the LOSi item detected at the OLT as described in Table 15 of ITU-T G.983.1 as cited above. This item is detected when no valid optical signal is received for the i-th ONU when expected during eight upstream sequential ATM cells.

In an embodiment of the present invention, the EMS or other management system may request an ONT connectivity test. In general, a test will be performed on active NTs that have already been ranged by the OLT, as an inactive NT will, in general, simply result in a failed test.

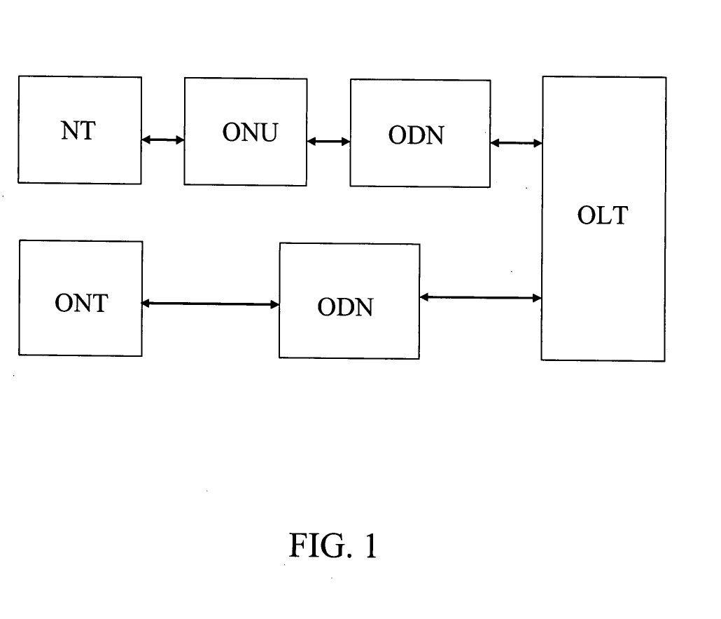

The EMS provides a test command to the OLT equipment (for example, a PON card within an OLT terminal). The OLT performs the test by sending a signal to a specified network termination. In general, the specified network termination will be a particular ONT. In alternate network architectures (for example, one in which a particular ONU is in communication with multiple non-optical network terminations), the specified network termination may not be an ONT, but rather a particular NT, as generally illustrated in FIG. 1. Though generally a single NT will be under test, it is also contemplated that multiple NTs may be tested at one time. In this case, the responsive signal should include or otherwise allow for identification of the particular NT from which it originates so that the tests can be separated and properly attributed to specific NTs.

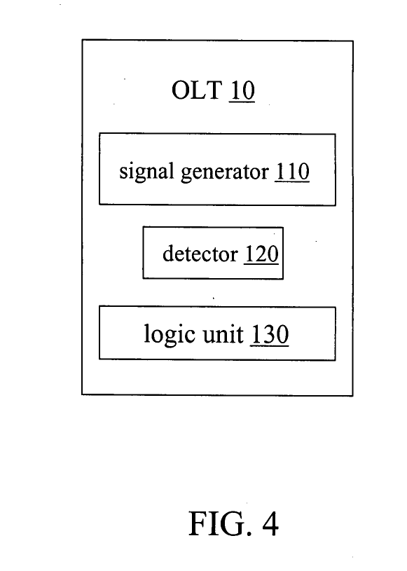

FIG. 4 shows a block diagram of an OLT 10 according to an embodiment of the invention, and a system configured to perform the above method is schematically illustrated in FIG. 4. OLT 10 includes communication ports for communicating with a management system 15 and with an ODN 40. These ports may in principle be merely notionally separate ports corresponding to, for example, time- or wavelength-division multiplexing over a single physical connection. The ODN further distributes communications from the OLT 10 to several ONTs 50a-c.

The OLT further includes a signal generator 110 for generating the connectivity test signal and/or a signal for reporting results of the connectivity test to the EMS 15. While only a single signal generator 110 is shown in the figure, there may in practice be multiple signal generators within the OLT for performing each communication function or there may be a single signal generator that is capable of performing both functions. The OLT likewise includes a detector 120 configured to receive responsive signals from any ONTs under test and a logic unit 130 that determines a result of a connectivity test (e.g. pass or fail) dependent on the received responsive signal or signals.

Each of the units 110, 120, 130 may be contained on one or more integrated circuit devices (e.g. ASICs), FPGAs, or other chips or chipsets, or one or more of these units may be contained on the same device or devices. In one arrangement, one or more of these units is implemented as a set (e.g. one or more sequences) of instructions executable by one or more arrays of logic elements (e.g. a processor). Logic unit 130 may include a timer, which may be implemented as a counter that counts a predetermined number of events (e.g. clock periods) between two moments (e.g. the transmission time and corresponding reception time), as a comparator that indicates a relation between two values (e.g. the transmission time and corresponding reception time), or in another fashion as may be known or may become known in the arts of circuit design and/or logic design.

The test signal may be, for example, a particularly defined connectivity message including messages specifically designated for a particular network system. Alternately, the test signal may be a command and response that is already defined within a standard communications protocol being used within the network. For example, within an ATM network, the connectivity test signal may include a “get” message, as defined in ITU-T standard G.983.2.

Alternate possibilities for test signals include commands to retrieve an attribute of the particular ONT or NT under test, including existing attributes and/or random valid attributes for that network termination. Likewise, vendor specific or proprietary attributes or messages could be retrieved.

In at least some embodiments of the present invention, it may be useful to set a time interval for network termination response. That is, for a given test message, the OLT would expect to receive a responsive message by to the end of the time interval. This time interval may be a preconfigured value (e.g. encoded in instructions available to, for example, the OLT or the NT) or it may be a user-specified variable, including variables specified by an end user or by a service provider. Because, in general, the test signal may be carried on an OMCI channel, the test messages may have to contend with other OMCI traffic on the network. As a result, it may generally be the case that test message response time is on the order of hundreds of milliseconds. In the case where such a delay is expected, for example, setting the time interval below a few hundreds of milliseconds may result in a high number of false test failures. In an alternate arrangement, the test messages can be sent independently from other OMCI traffic, and therefore be received on a separate queue (e.g. in accordance with section 9.3.1 of G.983.2 regarding prioritized protocol entities). In that case, it may be expected that the test message will not be delayed by other OMCI traffic.

One alternate solution to this problem is to carry the test signals on another channel, including an otherwise unassigned channel should one be available. For example, a proprietary channel, pre-selected by a service provider, a VCC (Virtual Circuit Connection), or PLOAM (Physical Layer Operations Administration Maintenance) cells may be used to send and receive test signals. On the other hand, it may be beneficial to avoid affecting other services provisioned within the OLT such as, for example, POTS services, TI services, Ethernet services, video services, xDSL, DS3, and OC3 services, etc. Furthermore, testing using the OMCI channel may provide a diagnostic tool for monitoring that channel, which may have additional benefit to overall system reliability and control.

In at least some embodiments of the present invention, multiple connectivity tests may be performed. For example, a number of tests may be performed over a given time period. Both the number of tests and the time period may be pre-programmed and/or according to user-definable system settings. In some such arrangements, the connectivity tests may be performed continuously at pre-programmed or user definable intervals and the data may be returned to the management system either on specific request or on a schedule (e.g., daily, weekly, etc.).

When multiple tests are performed on a given NT, statistics may be compiled to be returned to the management system. In particular, it may be useful to compile a report for the management system in which information regarding a number of tests performed, a number of tests passed, and a number of tests failed is returned to the management system from the OLT. Because the number of tests passed and failed should sum to equal the total number of tests, it is possible to provide all three pieces of information by simply returning any two, allowing for calculation of the third. Likewise, within the reporting OLT, any two may be compiled and the third may be calculated.

As noted above, a failure condition may be declared for any test in which the responsive signal is not detected within the time interval. In some applications of embodiments of the invention, in a case that the responsive signal is corrupted, the test may be considered failed. If, in the case of multiple tests, the responsive signals are returned out of order, then the out of order tests may be considered failed. The order may be monitored, for example, by checking against TCIDs to determine the expected order of response. A test sent to an un-ranged ONT may also be counted as a failed test.

Other tests tallied as failed may include tests in which there is an error in the format of either the transmitted or received signal. Formatting errors in either direction would generally indicate a fault on the communications line, as both the transmitting OLT and the responding NT would be expected to properly format their respective outgoing messages. Of course, if the OLT is entirely unable to send a connectivity test signal to the ONT, the test should be considered failed. Other types of (and events or combinations indicating) connectivity test failures not specifically mentioned herein are considered to be within the scope of the present invention, and the above list should not be considered limiting or exhaustive.

In certain embodiments, the OLT may terminate testing for any NT that encounters particular predetermined conditions. For example, in the case that an NT under test is or becomes disabled or deactivated, the testing may be terminated. Likewise, if an LOS or missing card alarm is declared for the OLT that is testing the NT, or another condition is detected that would be expected to result in all tests failing, then the test may be terminated.

In any of the above cases in which the OLT is unable to complete the testing sequence, it may be useful for it to compile a report of the complete testing nonetheless. In some such applications, any test not performed may be counted as a failed test. For example, if a sequence of 50 tests is to be performed, and after 30 of the tests, the NT under test becomes deactivated, the final 20 tests will not be performed. Assuming that 25 of the 30 executed tests were passed, the OLT may then report to the management system that of the 50 tests, 25 were passed and 25 failed. In such a situation, embodiments of the invention may allow for the reporting of a number of tests not attempted due to the underlying condition (in this case, deactivation of the NT). This additional information may allow the management system to make compensating adjustments to the network.

The foregoing presentation of the described embodiments is provided to enable any person skilled in the art to make or use the present invention. While specific embodiments of the invention have been described above, it will be appreciated that the invention as claimed may be practiced otherwise than as described. Various modifications to these embodiments are possible, and the generic principles presented herein may be applied to other embodiments as well.

An embodiment of the invention may be implemented in part or in whole as a hard-wired circuit (e.g. implemented on a computer interface card) and/or as a circuit configuration fabricated into one or more arrays of logic elements arranged sequentially and/or combinatorially and possibly clocked (e.g. one or more integrated circuits (e.g. ASIC(s)) or FPGAs). Likewise, an embodiment of the invention may be implemented in part or in whole as a firmware program loaded or fabricated into non-volatile storage (such as read-only memory or flash memory) as machine-readable code, such code being instructions executable by an array of logic elements such as a microprocessor or other digital signal processing unit.

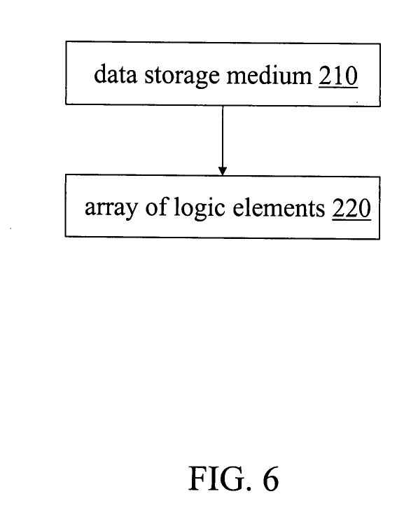

Further, an embodiment of the invention may be implemented in part or in whole as a software program loaded as machine-readable code from or into a data storage medium such as a magnetic, optical, magnetooptical, or phase-change disk or disk drive; or some form of a semiconductor memory such as ROM, RAM, or flash RAM (e.g. medium 210 as shown in FIG. 6), such code being instructions (e.g. one or more sequences) executable by an array of logic elements such as a microprocessor or other digital signal processing unit, which may be embedded into a larger device (e.g. array 220 as shown in FIG. 6). Thus, the present invention is not intended to be limited to the embodiments shown above but rather is to be accorded the widest scope consistent with the principles and novel features disclosed in any fashion herein.

1. A method comprising:
transmitting a signal from an OLT to at least one active network termination in communication therewith;
detecting, subsequent to the transmitting, a responsive signal from the active network termination;
based on the detecting, determining a result of a connectivity test; and
reporting the result to a network management system.

2. The method according to claim 1, comprising transmitting a plurality of signals to perform a plurality of connectivity tests,
wherein said reporting further comprises communicating, to the network management system, a number of signals transmitted and a number indicative of a number of the tests for which a fail condition is determined.

3. The method according to claim 2, wherein the number indicative of a number of the tests for which a fail condition is determined is a number of failed tests.

4. The method according to claim 2, wherein the number indicative of a number of the tests for which a fail condition is determined is a number of passed tests, and wherein the method further comprises calculating a number of failed tests by subtracting the number of passed tests from a number of tests equal to a number of the plurality of signals.

5. The method according to claim 1, wherein the determining further comprises determining a fail condition based on failure to detect the responsive signal within a predetermined time interval.

6. The method according to claim 5, wherein the predetermined time interval comprises a user-configurable time interval.

7. The method according to claim 5, wherein the predetermined time interval comprises a time interval pre-configured in machine-executable instructions available for execution by at least one of the OLT and the network termination.

8. The method according to claim 1, wherein the determining further comprises determining a fail condition for any test having a result selected from the group consisting of no response, no response within a preselected time interval, corrupt response, out of sequence response, response containing a formatting error, and error in the transmitting.

9. The method according to claim 1, wherein the transmitting occurs on an OMCI channel of an ATM network.

10. The method according to claim 1, wherein the transmitting is initiated at the command of the network management system.

11. The method according to claim 1, wherein the transmitting is initiated according to a predetermined schedule and wherein the reporting is initiated according to an intermittent command.

12. The method according to claim 11, wherein the reporting is initiated according to a user-issued command.

13. The method according to claim 11, wherein the reporting is initiated according to a predetermined schedule.

14. The method according to claim 1, wherein the transmitting, detecting, determining and reporting are executed such that other communications between the OLT and the at least one network termination continue without interruption.

15. An optical line termination comprising:
a first communication port adapted to communicate with at least one active network termination;
a second communication port adapted to communicate with a network management system;
a first signal generator configured and arranged to transmit a signal to the at least one network termination;
a signal detector configured and arranged to receive a responsive signal from the network termination;
a logic unit configured and arranged to determine, based on the received responsive signal, a result of a connectivity test; and
a second signal generator configured and arranged to report the result to the network management system.

16. The optical line termination according to claim 15, wherein said first signal generator is configured to transmit a plurality of signals for a plurality of connectivity tests, and
wherein said second signal generator is configured to communicate, to the network management system, a number of signals transmitted and a number indicative of a number of the tests for which a fail condition is determined.

17. The optical line termination according to claim 15, wherein said logic unit is configured to determine a fail condition based on failure to detect the responsive signal within a predetermined time interval.

18. The optical line termination according to claim 15, wherein the first signal generator is configured to transmit the signal on an OMCI channel of an ATM network.

19. A data storage medium having machine-executable instructions describing a method comprising:
transmitting a signal from an OLT to at least one active network termination in communication therewith;
detecting, subsequent to the transmitting, a responsive signal from the active network termination;
based on the detecting, determining a result of a connectivity test; and
reporting the result to a network management system.

20. The medium according to claim 19, wherein said method comprises transmitting a plurality of signals to perform a plurality of connectivity tests,
wherein said reporting comprises communicating, to the network management system, a number of signals transmitted and a number indicative of a number of the tests for which a fail condition is determined.

21. The medium according to claim 19, wherein said determining further comprises determining a fail condition based on failure to detect the responsive signal within a predetermined time interval.
